(19) United States
(12) Patent Application Publication
(10) Pub. No.: US 2018/0051847 A1
(43) Pub. Date: Feb. 22, 2018

(54) SPHERICAL GIMBAL SYSTEM USING GROOVED ROTATABLE BALL, ORTHOGONALLY ORIENTED TOOTHED GEARS, AND SOCKET CASING

(71) Applicant: Toren Arginteanu, Cresskill, NJ (US)

(72) Inventor: Toren Arginteanu, Cresskill, NJ (US)

(21) Appl. No.: 15/241,073

(22) Filed: Aug. 19, 2016

(51) Int. Cl. F16M 11/14; F16H 19/00; F16H 57/02; F16C 11/06; F16M 11/18

(52) U.S. Cl. CPC F16M 11/14; F16H 19/001; B64C 39/024; F16C 11/06; F16M 11/18; F16H 57/02

(57) ABSTRACT

The present invention relates to a novel gimbal system. A grooved spherical ball has been designed to rotate with precise control over multiple degrees of freedom. A concave housing surrounds and stabilizes the ball. The ball articulates with and is moved by the actuation of two orthogonally situated toothed gears. Such improved gimbal design may be useful in systems which require precise, stable and rapid motion through multiple degrees of freedom such as the stabilization of cameras mounted on moving devices as well as myriad other diverse applications.

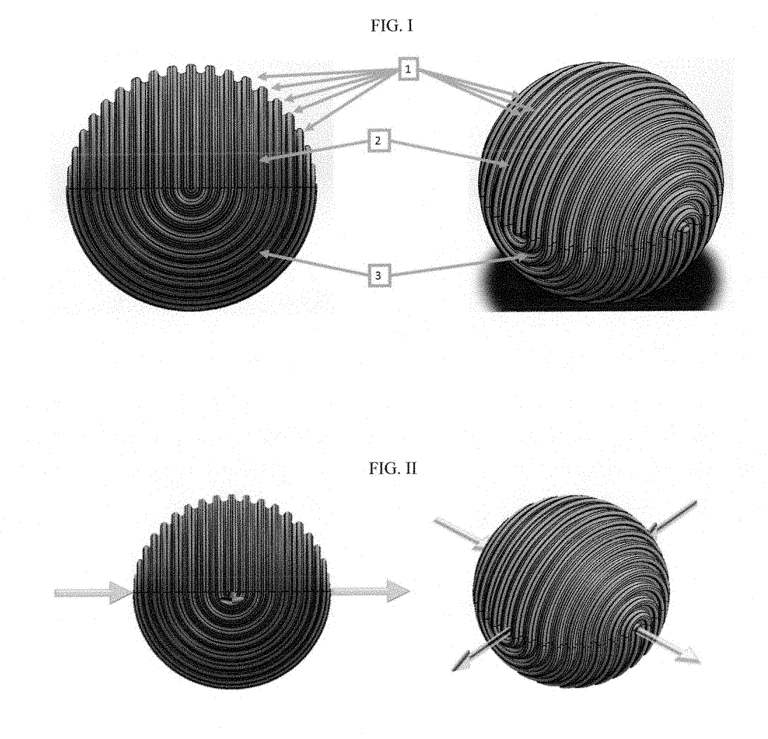

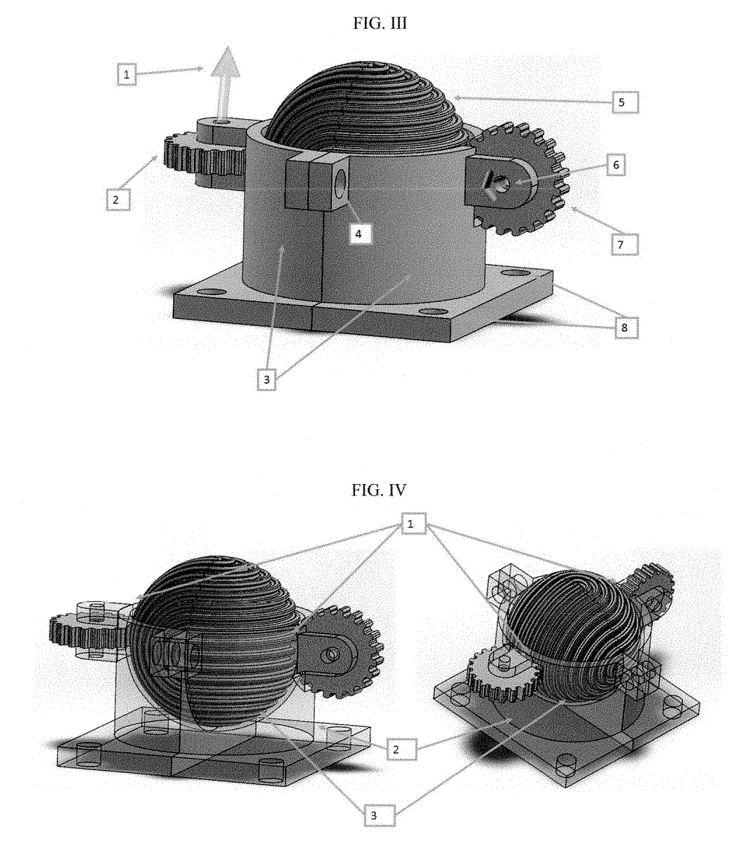

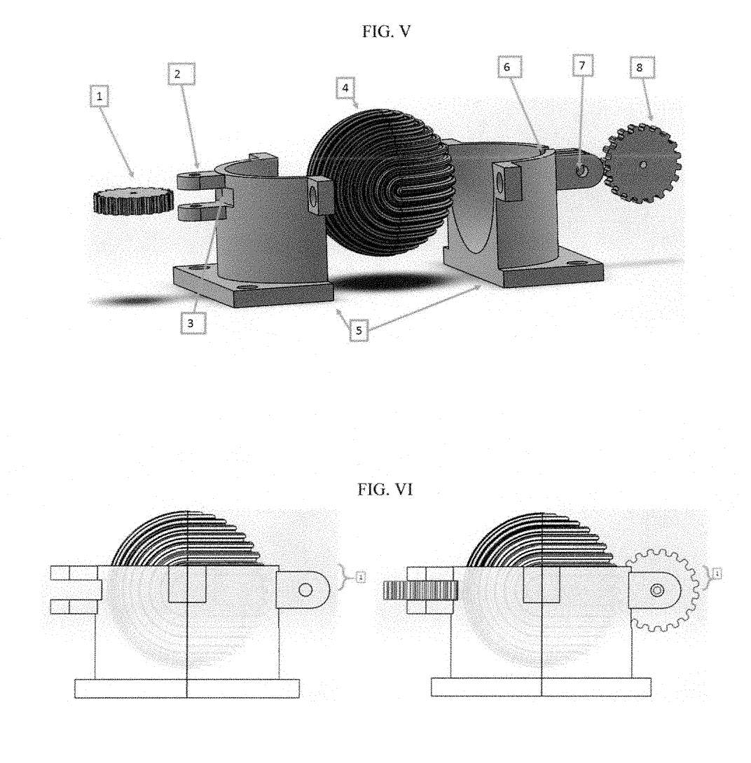

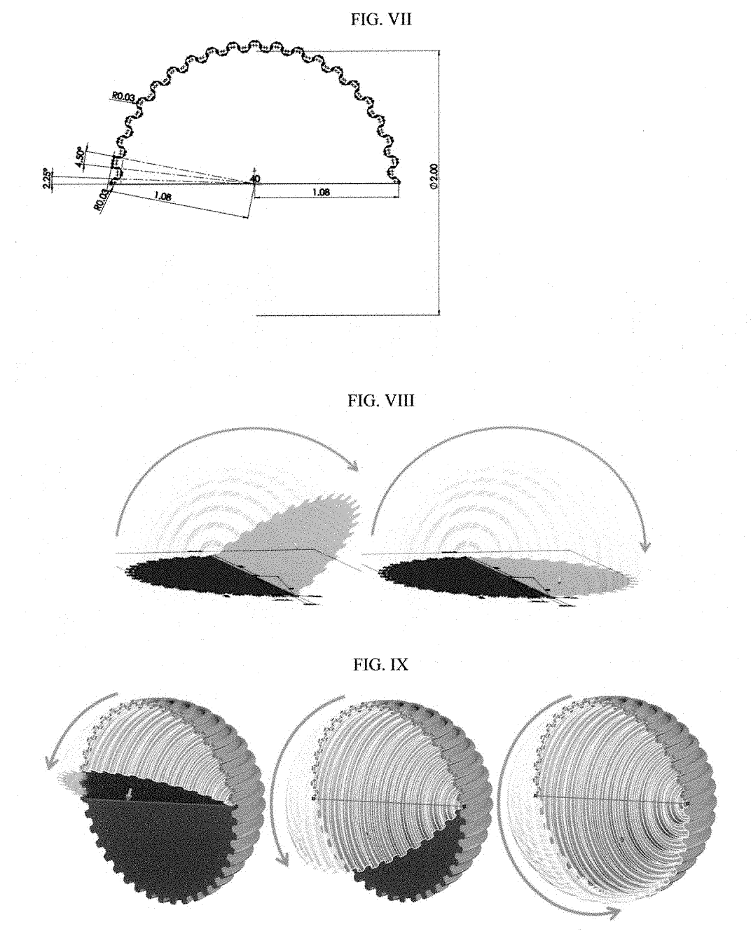

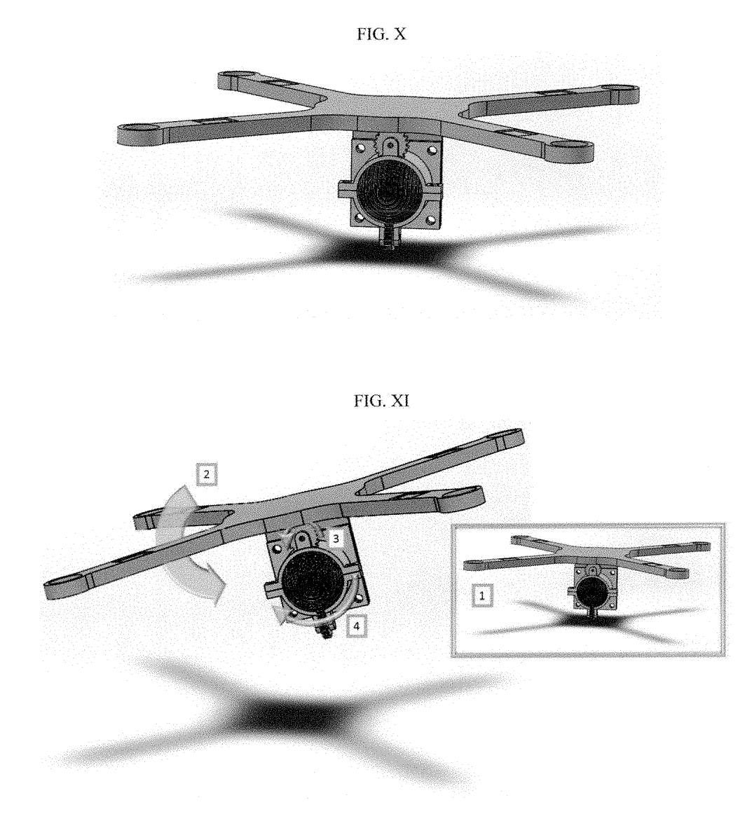

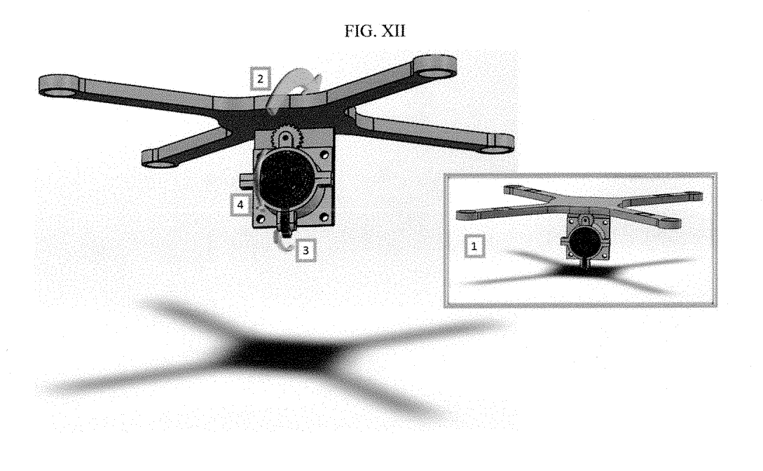

### TECHNICAL FIELD

Certain embodiments of the present disclosure generally relate to gimbal devices, which have proven useful in many embodiments as described below and in the prior art. The specific gimbal described herein has numerous advantages over prior art and may be used as part of any machine incorporating a gimbal system.

### BACKGROUND

As is known in the mechanical arts, gimbal systems are useful for a wide range of applications. Several well-known examples include gimbal suspension systems with two degrees of freedom which are used to support coin operated telescopes at scenic spots of public parks. A gimbal utilizing three degrees of freedom is found in altitude sensing gyroscopes in aircraft and space platforms. Rocket engines are mounted on gimbals allowing the exhaust nozzle of the rocket to be swiveled from side to side. In the arts of photography and imaging, a gimbal head rotates a lens allowing for easy and smooth manipulation while tracking moving subjects.

Attempts to improve gimbal systems have been the subject of multiple previous patents. Knowles et al., in U.S. Pat. No. 106,170 described a non-mechanical system that includes a gimbal housing, rotatable sphere and curvilinear actuators. The curvilinear actuators rotate the sphere, via shear induced motion. Nishimura et al., in U.S. Pat. No. 6,734,914 and Sugaya, in U.S. Pat. No. 5,872,417 each described gimbal systems permitting 360 degrees of rotation. The devices they describe are actuated by piezoelectric elements which drive a spherical rotary unit. Blackburn et al., in U.S. Pat. No 90,195, described a turret based gimbal mechanism which rotates a sphere by the action of a pair of opposing yoke arms. Wilson et al., in U.S. Pat. No. 38,421 described a joint system capable of providing motion through multiple degrees of freedom. Van Der Walt, in U.S. Pat. No. 8,179,007 described a ball in socket type gimbal arrangement which is actuated via electromagnetic force. Furuta, in U.S. Pat. No. 6,536,724 described a gimbal that is supported by two columns fixed to a mounting surface. Additional rotational control is provided by a sensor head fixed to the gimbal. Cooper et al., in U. S. Pat. No. 66,002 described a system comprised of multiple stacked disks. Pitch and yaw are controlled via actuation cables.

The previous art does not provide a mechanically simplified, lightweight, component-minimized, compact device which provides for the unlimited rotational drive of its spherical element that eliminates the undesirable exertion of force against its motor interface. Many existing gimbal devices exert undue force against their motor interface, wasting energy and rendering the system inefficient. (This occurs when one actuator exerts undue force and torque against the other according to Newton's third law.) Furthermore, the prior art typically relies on friction, piezoelectric effect, and/or electromagnetic forces to actuate the movement of the gimbal, limiting fine motor control, speed, and accuracy, and possibly causing wear on the components. Many such prior art devices involve various moving parts mechanically connected to each other. The mechanical connections create resonances, instabilities, and hysteresis, making the prior art devices difficult to adjust and maintain in alignment.

Therefore, what is preferred is an improved gimbal system capable of rapidly rotating a sphere in multiple degrees of freedom using a gear-toothed rotatable ball within a socket joint. The manner in which the teeth of the actuating gears engage with the grooves in the spherical ball allows for superior mechanical power transmission and more precise control throughout multiple degrees of freedom.

### SUMMARY OF THE DISCLOSURE

This invention relates generally to gimbal systems and may be used advantageously in place of gimbal systems designed and utilized as described above or in any other device which calls for a gimbal. One embodiment of the invention is represented by FIG. IV. A cup shaped housing supports a ball. The movement ball is controlled by two orthogonally oriented gears whose teeth engage grooves on the ball. The spherical ball has been uniquely designed with grooves constructed by rotating a gear perpendicularly around each hemisphere [Figs VIII and IX]. The specific design of the grooves and interaction with the teeth of the gears provides for the advantageous attributes of the system.

This gimbal system could be adapted for use on a moving apparatus such as, but not limited to, drone (unmanned aerial vehicle) [FIG. X] photography. Such systems generally offer two axes of rotation to stabilize a camera in the pitch [FIG. XII] and roll [FIG. XI] directions, which are notoriously unsteady on a drone in flight. Without a fast-responding gimbal system offering the necessary degrees of freedom, drone photography would be of poor quality; without an energy efficient system, much needed and already limited battery power will drain quickly. Among many other applications, the fine motor control and multiple degrees of freedom offered by this novel gimbal system could also be used in the design of robotic eyes, medical and/or surgical instrumentations, rocket-propelled devices and spacecraft, and in general any system in which one device must be stabilized and/or rotated freely about multiple axes with respect to another device.

Other features and advantages of the invention, as well as the invention itself, will become more readily apparent when taken together with the following detailed description and the accompanying drawings, in which:

1. FIG. I illustrates the ball (sphere) from the front view (left) and isometric view (right):
(i) Number 1 represents some of the grooves on the ball, which interlock with gears' actuator teeth;
(ii) Number 2 represents the superior hemisphere, and
(iii) Number 3 represents the inferior hemisphere.

2. FIG. II indicates the two axes of rotation thereof.

3. FIG. III demonstrates the assembled gimbal system:
(i) Number 1 represents horizontally-oriented gear's axis of rotation;
(ii) Number 2 represents horizontally-oriented gear;
(iii) Number 3 represents housing components;
(iv) Number 4 represents the hole for attaching housing components together (e.g. via nut and bolt);
(v) Number 5 represents the ball (sphere);
(vi) Number 6 represents vertically-oriented gear's axis of rotation;
(vii) Number 7 represents vertically-oriented gear; and
(viii) Number 8 represents the holes for attaching gimbal system to another device (e.g. unmanned aerial vehicle).

4. FIG. IV illustrates the same, with housing made transparent to show internal workings:
(i) Number 1 represents interlocking of actuator teeth with grooves on the ball;
(ii) Number 2 represents housing (shown transparent); and
(iii) Number 3 represents the ball.

5. FIG V gives an exploded view of the assembly to better showcase its components:
(i) Number 1 represents the horizontally-oriented gear;
(ii) Number 2 represents the axle hole for the stabilization of Number 1;
(iii) Number 3 represents the aperture for allowing Number 1 to contact the ball;
(iv) Number 4 represents the ball;
(v) Number 5 represents the housing components;
(vi) Number 6 represents the aperture for allowing Number 8 to contact the ball;
(vii) Number 7 represents the axle hole for the stabilization of Number 8; and
(viii) Number 8 represents the vertically-oriented gear.

6. FIG. VI gives a wireframe view of the assembly, showing the position of the ball within the housing. The top of the cup extends high enough to cover more than half of the ball, preventing the ball from falling out of the cup if the assembly were turned upside-down.

7. FIG. VII shows a detailed example of a two-dimensional outline of half a gear, which will be used below to construct the ball (sphere).

8. FIG. VIII illustrates the construction of the superior hemisphere via rotating the above gear sketch about its diameter.

9. FIG. IX illustrates the construction of the inferior hemisphere via rotating a gear sketch about a diameter perpendicular to the previous one.

10. FIX. X provides a simplified diagram of the gimbal system mounted on a quadcopter-style UAV in a position level with the ground.

11. FIG. XI shows the roll of the UAV and the gimbal's stabilizing response:
(i) Number 1 represents the UAV in level position, for comparison;
(ii) Number 2 represents the rolling motion of the UAV;
(iii) Number 3 represents the actuation of gimbal gear to drive the gimbal ball; and
(iv) Number 4 represents the motion of the gimbal ball to counter Number 2.

12. FIG. XII shows the pitch of the UAV and the gimbal's stabilizing response:
(i) Number 1 represents the UAV in level position, for comparison;
(ii) Number 2 represents the pitching motion of the UAV;
(iii) Number 3 represents the actuation of gimbal gear to drive the gimbal ball; and
(iv) Number 4 represents the motion of the gimbal ball to counter Number 2.

The subject invention is directed to a new and useful gimbal system. A spherical ball has been designed with parallel, semi-circumferential grooves wrapping around each hemisphere [FIG. I] to engage with the actuator teeth on gears [FIG. IV, 1]. This ball is capable of rotating with multiple degrees of freedom [FIG. II] relative to its socket-like housing [FIG. III, 3; FIG. V, 5]. The ball is driven by the actuation of two orthogonally oriented gears [FIG. III, 2 and 7], each engaging with the grooves on one hemisphere of the ball. The present disclosure overcomes drawbacks experienced in the prior art and provides additional benefits. An electronic device such as a camera or an infrared sensor or another mechanical device can be attached to the rotating part of the gimbal.

The grooved ball is designed by taking the two-dimensional outline of half a gear—a toothed, semicircular shape [FIG. VII]— and rotating it 180 degrees about its diameter line, producing a grooved superior hemisphere [FIG. VIII]. From the flat face of this superior hemisphere (which, by necessity, lies upon the plane on which the original gear outline was drawn), a second outline of a half-gear is rotated 180 degrees about a diameter line perpendicular to the original diameter line [FIG. IX], producing the inferior hemisphere. As a result, the “engagement grooves” on the superior hemisphere are perpendicular to those on the inferior hemisphere [FIG. I], so that one standard “two dimensional” gear can engage with the superior hemisphere's grooves, while a perpendicularly oriented “two-dimensional” gear can engage with the inferior hemisphere's grooves [FIG. IV, 1]. By rotating the two gears, one can drive the ball about the pitch axis and the roll axis, respectively. Because the grooves on a given hemisphere wrap around the curvature to the ball parallel to each other, when one gear drives the ball about one axis, the other gear's engagement teeth slide freely along the gear's grooves without impeding the ball's motion. The fact that rotating the lightweight ball is the only motion necessary to produce the desired effect is an improvement upon prior art, much of which required moving heavier components with longer lever arms, resulting in unnecessary torque and therefore inefficient waste of energy.

The socket is a secure, concave housing stabilizing the spherical ball [FIG. III, 3]. Apertures have been designed in the socket [FIG. V, 3 and 6] to allow the gears to engage with the ball, with holes [FIG. V, 2 and 7] through which small pins to hold the gears in place may pass. This structure allows rotation through multiple degrees of freedom, but constricts motion of the ball and gears so that each gear is forced to turn only about its axis and the ball is free to rotate about both axes but not to exit the cup and roll away from the gears. The benefits of having both gears fixed in space relative to the cup (which may be fixed in space relative to a drone or other instrument) as compared to existing gimbal systems used on drones are numerous. Since both gears are fixed, any motors or servo motors employed to drive them can also be fixed. Unlike in many existing gimbal systems, the position of one motor is completely independent from that of the other. This, along with the ability of an inactive gear to slide freely through the groves on the ball while an active gear drives the ball, means that one motor will not exert a reverse force or torque against the other (in accordance with Newton's third law), causing both motors to expend unnecessary energy just to keep the system stationary. It also greatly reduces the potential of motor wires becoming tangled during motion of the system. When fully assembled, the cup is designed to cover just barely more than half of the ball [FIG. VI, 1], so that the ball and any device attached to it will not fall out of the cup even when the system is turned upside-down and the exposed portion of the ball faces down. Within this constraint, the amount of ball to be exposed must be maximized so as to give the ball as close to a hemispherical view as possible, maximizing the possible degrees of freedom.

In order to optimize the performance of the gimbal system, the range of motion of the ball should be as close to hemispherical as possible. The field of view is limited by the region of the cup that covers the ball (which is necessary to keep the ball in place) and by the region on the surface of the ball that might be occupied by a camera or other device. Thus, the size of the ball should be as large as possible with respect to the size of the camera and the height of the cup, and these quantities should be minimized with respect to the size of the ball. The maximization of the ball size must be within reason, especially if the gimbal is to be attached onto a moving object such as a drone. Additionally, the ball should fit as snugly as possible within the socket to prevent escape of the ball and to minimize non-rotational motion of the ball within the cup (such as shaking), but the size difference between ball and socket must not be so small that the ball does not fit or there is too much friction inhibiting or preventing the ball's rotation. This limitation could be ameliorated by lubricating the ball and socket joint.

These and other features of the integrated gimbal system of the subject invention and the manner in which it is employed will become more readily apparent to those having ordinary skill in the art from the following enabling description of the preferred embodiments of the subject invention taken in conjunction with the several drawings described below. Embodiments of the present invention may also be capable of other and different applications, and its several details may be modified in various respects, all without departing from the spirit and scope of embodiments of the present invention. Accordingly, the drawings and descriptions are to be regarded as illustrative in nature, and not as restrictive. The drawings are not necessarily drawn to scale. The description is intended to cover all modifications, equivalents and alternatives falling within the spirit and scope of the claims.

1. The specific groove design on the spherical ball is novel and unique:
a. It allows for precise movement through multiple degrees of freedom when driven by the actuation of two orthogonally situated toothed gears.

2. The concave housing is an improvement upon prior art
a. It allows for stabilization of the gimbal using a tooth in groove mechanism which maximizes precision

3. The interaction between ball and gears improves upon prior art
a. It forces near-immediate response of the gimbal system to a driving input from the actuators.
b. Actuation and stabilization of the ball do not rely on friction or any force which would cause fast-acting and substantial wear on the ball
c. The minimal driving of mass necessary to change the position of the gimbal minimizes the work required of the actuators, thereby conserving energy

4. The fixed position of the actuators in space improves upon prior art
a. It allows gimbal function while minimizing energy expenditure, as the movement caused by one gear does not cause force to be exerted against the second.
b. It minimizes potential tangling of wires.
